(19) United States
(12) Patent Application Publication
(10) Pub. No.: US 2026/0113155 A1
(43) Pub. Date: Apr. 23, 2026

(54) SYSTEMS, APPARATUSES AND METHODS FOR ENHANCED LONG RANGE PACKET TRANSMISSION FOR WIRELESS COMMUNICATION

(71) Applicant: HUAWEI TECHNOLOGIES CO., LTD., SHENZHEN (CN)

(72) Inventors: Sara NOROUZI, Kanata (CA); Jung Hoon SUH, Kanata (CA); Yan XIN, Kanata (CA); Mahmoud HASABELNABY, Kanata (CA); Osama ABOUL-MAGD, Kanata (CA)

(73) Assignee: HUAWEI TECHNOLOGIES CO., LTD., SHENZHEN (CN)

(21) Appl. No.: 19/010,904

(22) Filed: Jan. 6, 2025

Related U.S. Application Data
(60) Provisional application No. 63/709,789, filed on Oct. 21, 2024.

(51) Int. Cl. H04L 5/00; H04W 84/12

(52) U.S. Cl. CPC H04L 5/0044; H04L 5/0092; H04W 84/12

(57) ABSTRACT

An enhanced long range (ELR) communication methods are provided. An ELR communication method includes transmitting a packet using even-indexed tone selection. Another ELR communication method includes transmitting a packet using two times duplication of even-indexed 106-tone resource units (RUs) in frequency domain.

### CROSS-REFERENCE TO RELATED APPLICATIONS

This application claims the benefit of U.S. provisional patent application No. 63/709,789 filed on Oct. 21, 2024, the contents of which are incorporated herein by reference in their entirety.

### FIELD OF THE DISCLOSURE

The present disclosure relates generally to communication systems, apparatuses, methods, and non-transitory computer-readable storage devices, and in particular to systems, apparatuses and methods for enhanced long range (ELR) packet transmission for wireless communication.

### BACKGROUND

Wireless communication systems such as IEEE 802.11 series (that is, Wi-Fi® series; Wi-Fi is a registered trademark of Wi-Fi Alliance, Austin, TX, USA) are known. In recent IEEE 802.11 series, enhanced long range (ELR) is proposed for ultra high reliability (UHR) to address the link budget and range imbalance issues between downlink (DL) and uplink (UL). In effect, station's (STA's) UL range is limited due to lower transmitter (Tx) power. Specifically, an access point (AP) STA in general transmits higher power than non-AP STAs. Link budget difference between downlink and uplink can be 6 dB. Hence, UL range is shorter than a DL beacon.

The IEEE802.11ax extended-range (ER) solution is complex and limited. In addition, the uplink-orthogonal frequency division multiple access random access (UORA) for association with the ER solution is not popular in products on the market due to the associated low airtime efficiency. As such, the definition of a long range orthogonal frequency division multiplexing (OFDM) PHY protocol data unit (PPDU) with better coexistence and performance than IEEE802.11b is needed. The UHR target for enhanced long-range design is the definition of an ELR PPDU that supports a minimum data rate of 1.5 Mbps and improves uplink link budget by 6 dB.

Therefore, there is a need for a method, apparatus and system for wireless communication that obviates or mitigates one or more limitations of the prior art.

This background information is provided to reveal information believed by the applicant to be of possible relevance to the present disclosure. No admission is necessarily intended, nor should be construed, that any of the preceding information constitutes prior art against the present disclosure.

### SUMMARY

An object of embodiments of the present disclosure is to provide a method, system and apparatus for enhanced long range (ELR) packet transmission for wireless communication.

According to an aspect of the present disclosure, there is provided an enhanced long range (ELR) communication method. The method includes transmitting a packet using even-indexed tone selection.

In some embodiments, 52 of the even indexed 106-tone RUs are used for data transmission and a remaining even indexed 106-tone RU is set to zero or is configured as an extra pilot tone. In some embodiments, 53 of the even indexed 106-tone RUs are used for data transmission.

In some embodiments, the packet further includes an enhanced long range modulation coding scheme (ELR-MCS) having two bits in an enhanced long range signal (ELR-SIG) field of an enhanced long range physical layer protocol data unit (ELR-PPDU).

In some embodiments, the transmit power in the data portion is boosted by 3 dB.

According to an aspect of the present disclosure, there is provided an enhanced long range (ELR) communication method. The method includes transmitting a packet using two times duplication of even-indexed 106-tone resource units (RUs) in frequency domain.

According to an aspect of the present disclosure, there is provided an enhanced long range (ELR) communication method. The method includes transmitting a packet including a truncated half of a data symbol and a guard interval. In some embodiments, the method further includes retransmitting the packet.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus comprising: one or more processors functionally connected to one or more memories for performing the above-described methods.

According to one aspect of this disclosure, there is provided one or more non-transitory computer-readable storage devices comprising computer-executable instructions, wherein the instructions, when executed, cause one or more circuits to perform the above-described methods.

According to one aspect of this disclosure, there is provided an apparatus, and configured to perform the any one of the above mentioned methods and their embodiments. Specifically, the apparatus includes one or more units configured to perform the any one of the above mentioned methods and their embodiments.

According to one aspect of this disclosure, there is provided a computer-readable storage medium. The computer-readable storage medium stores a computer program, and when the computer program is executed by an apparatus, the apparatus is enabled to implement the any one of the above mentioned methods and their embodiments.

According to one aspect of this disclosure, there is provided a computer program product including one or more instructions. When the instructions are executed by an apparatus such as a computer, the apparatus is enabled to implement the any one of the above mentioned methods and their embodiments.

According to one aspect of this disclosure, there is provided a computer program. When the computer program is executed by a computer, an apparatus is enabled to implement the any one of above mentioned methods and their embodiments.

According to one aspect of this disclosure, there is provided a communication system. The communication system includes a first communication-node and/or a second communication-node, the first communication-node is configured to perform the methods regarding with the first communication-node as stated above, and the second communication-node is configured to perform the methods regarding with the second communication-node as stated above.

According to one aspect of this disclosure, there is provided an apparatus for implementing the methods in any possible implementation of the foregoing aspects.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present disclosure will become apparent from the following detailed description, taken in combination with the appended drawings, in which:

FIG. 1 is a simplified schematic diagram showing a communication system, according to some embodiments of this disclosure.

FIG. 2 is a simplified schematic diagram of an access point (AP) of the communication network of the communication system shown in FIG. 1.

FIG. 3 is a simplified schematic diagram of a station (STA) of the communication system shown in FIG. 1.

FIG. 4 is a schematic diagram showing 4 times duplication with 52-tone regular resource unit (RRU) and peak-to-average power ratio (PAPR) reduction in enhanced long range (ELR) transmission.

FIG. 5 is a schematic diagram showing 106-tone regular resource units (RRUs) in 20 MHz bandwidth (BW) according to embodiments of the present disclosure.

FIG. 6 is a schematic diagram of tone allocation for the long training field (LTF) and data symbols with the 2×-symbol transmission in ELR according to embodiments of the present disclosure.

FIG. 7 is a schematic diagram showing a PAPR reduction mask according to embodiments of the present disclosure.

FIG. 8 is a graph showing PAPR comparison of 50 k Data Symbols on BW 20 MHz with binary phase shift keying (BPSK) and 4× inverse fast Fourier transform (IFFT), according to embodiments of the present disclosure.

FIG. 9 is a graph showing PAPR comparison of 50 k Data Symbols on BW 20 MHz with quadrature phase shift keying (QPSK) and 4×IFFT, according to embodiments of the present disclosure.

FIG. 10 illustrates an enhanced long range communication method according to embodiments of the present disclosure.

It will be noted that throughout the appended drawings, like features are identified by like reference numerals.

### DETAILED DESCRIPTION

Embodiments disclosed herein relate to systems, apparatuses, methods, and non-transitory computer-readable storage devices for wireless communication. The wireless communication systems, apparatuses, and methods disclosed herein may be any suitable systems, apparatuses, and methods for transmitting wireless signals. Examples of such systems may be wireless local-area network (WLAN) ultra-high reliability (UHR) systems (for example, IEEE 802.11bn or Wi-Fi® 8 systems), 5G or 6G wireless mobile communication systems, and the like.

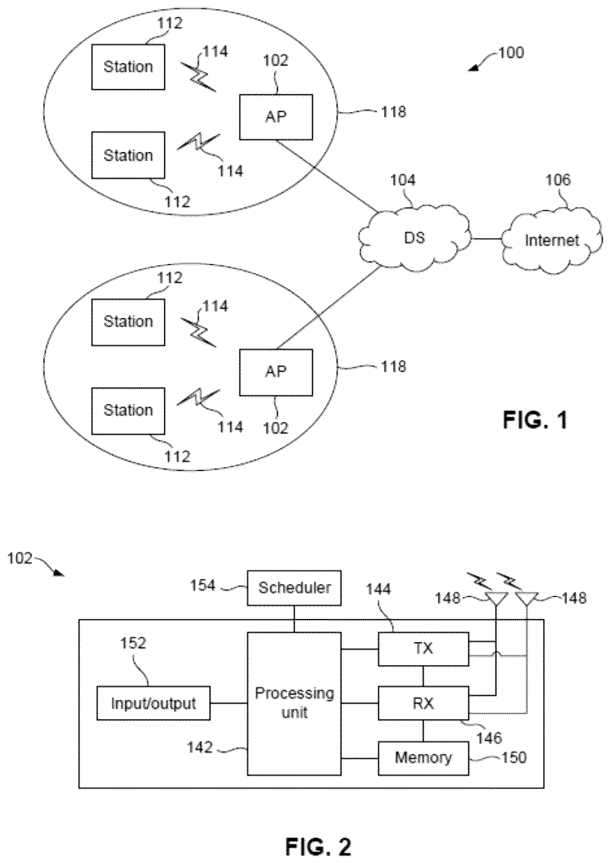

Turning now to FIG. 1, a communication system according to some embodiments of this disclosure is shown and is generally identified using reference numeral 100. As an example, the communication system 100 may be a Wi-Fi® system built under relevant standards such as IEEE 802.11 standard. As shown, the communication system 100 includes a plurality of interconnected networking devices 102 such as a plurality of interconnected access points (APs; also called “base stations”) forming a distribution system (DS) 104 which is in turn connected to other networks such as the Internet 108 which may include a network of computers and subnets (intranets) or both, and incorporate protocols, such as Internet protocol (IP), transmission control protocol (TCP), user datagram protocol (UDP), and/or the like.

Each AP 102 is in wireless communication with one or more mobile or stationary stations 112 (STAs) through respective wireless channels 114 for providing wireless network connects thereto. Herein, the APs 102 and STAs 112 may be considered as different types of network nodes (or simply “nodes”) of the communication system 100. Each AP 102 and the STAs 112 connected thereto form a cell or basic service set (BSS) 118.

FIG. 2 is a simplified schematic diagram of an AP 102. As shown, the AP 102 includes at least one processing unit 142 (also denoted at least one “processor”), at least one transmitter (Tx) 144, at least one receiver (RX) 146 (collectively referred to as a transceiver), one or more antennas 148, at least one memory 150, and one or more input/output components or interfaces 152. A scheduler 154 may be coupled to the processing unit 142. The scheduler 154 may be included within or operated separately from the AP 102. Each of these components 142 to 154 may be implemented as one or more circuits (such as one or more electronic circuits and/or one or more optical circuits). Alternatively, the ensemble of these components 142 to 154 may be implemented as one or more circuits.

The processing unit 142 Is configured for performing various processing operations such as signal coding, data processing, power control, input/output processing, or any other suitable functionalities. The processing unit 142 may comprise a microprocessor, a microcontroller, a digital signal processor, a FPGA, an ASIC, and/or the like. In some embodiments, the processing unit 142 may execute computer-executable instructions or code stored in the memory 150 to perform various the procedures (otherwise referred to as methods) described below.

Each transmitter 144 may comprise any suitable structure for generating signals, such as control signals as described in detail below, for wireless transmission to one or more STAs 112. Each receiver 146 may comprise any suitable structure for processing signals received wirelessly from one or more STAs 112. Although shown as separate components, at least one transmitter 144 and at least one receiver 146 may be integrated and implemented as a transceiver. Each antenna 148 may comprise any suitable structure for transmitting and/or receiving wireless signals. Although common antennas 148 are shown in FIG. 2 as being coupled to both the transmitter 144 and the receiver 146, one or more antennas 148 may be coupled to the transmitter 144, and one or more other antennas 148 may be coupled to the receiver 146.

In some embodiments, an AP 102 may comprise a plurality of transmitters 144 and receivers 146 (or a plurality of transceivers) together with a plurality of antennas 148 for communication in its cell 118.

Each memory 150 may comprise any suitable volatile and/or non-volatile storage such as RAM, ROM, hard disk, optical disc, SIM card, solid-state memory, memory stick, SD memory card, and/or the like. The memory 150 may be used for storing instructions executable by the processing unit 142 and data used, generated, or collected by the processing unit 142. For example, the memory 150 may store instructions of software, software systems, or software modules that are executable by the processing unit 142 for implementing some or all of the functionalities and/or embodiments of the procedures performed by an AP 102 described herein.

Each input/output component 152 enables interaction with a user or other devices in the communication system 100. Each input/output device 152 may comprise any suitable structure for providing information to or receiving information from a user and may be, for example, a speaker, a microphone, a keypad, a keyboard, a display, a touch screen, a network communication interface, and/or the like.

Herein, the STAs 112 may be any suitable wireless device that may join the communication system 100 via an AP 102 for wireless operation. In various embodiments, a STA 112 may be a wireless electronic device used by a human or user (such as a smartphone, a cellphone, a personal digital assistant (PDA), a laptop, a desktop computer, a tablet, a smart watch, a consumer electronics device, and/or the like). A STA 112 may alternatively be a wireless sensor, an Internet-of-things (IoT) device, a robot, a shopping cart, a vehicle, a smart TV, a smart appliance, a wireless transmit/receive unit (WTRU), a mobile station, or the like. Depending on the implementation, the STA 112 may be movable autonomously or under the direct or remote control of a human, or may be positioned at a fixed position.

In some embodiments, a STA 112 may be a multimode wireless electronic device capable of operation according to multiple radio access technologies and incorporate multiple transceivers necessary to support such.

In addition, some or all of the STAs 112 comprise functionality for communicating with different wireless devices and/or wireless networks via different wireless links using different wireless technologies and/or protocols. Instead of wireless communication (or in addition thereto), the STAs 112 may communicate via wired communication channels to other devices or switches (not shown), and to the Internet 106. For example, a plurality of STAs 112 (such as STAs 112 in proximity with each other) may communicate with each other directly via suitable wired or wireless sidelinks.

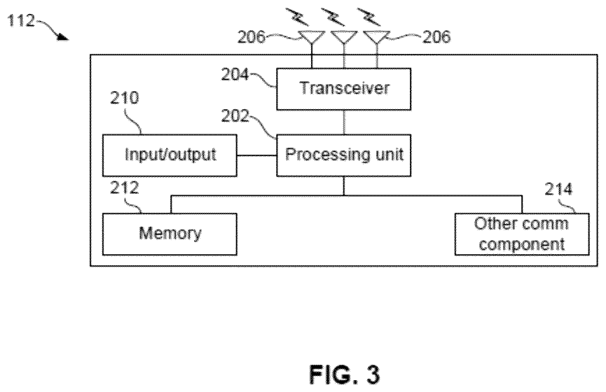

FIG. 3 is a simplified schematic diagram of a STA 112. As shown, the STA 112 includes at least one processing unit 202, at least one transceiver 204, at least one antenna or network interface controller (NIC) 206, one or more input/output components 210, at least one memory 212, and at least one other communication component 214. Each of these components 202 to 214 may be implemented as one or more circuits (such as one or more electronic circuits and/or one or more optical circuits). Alternatively, the ensemble of these components 202 to 214 may be implemented as one or more circuits. In various embodiments, the STA 112 may also comprise other components as needed or as desired.

The processing unit 202 is configured for performing various processing operations such as signal coding, data processing, power control, input/output processing, or any other functionalities to enable the STA 112 to access and join the communication system 100 and operate therein. The processing unit 202 may also be configured to implement some or all of the functionalities of the STA 112 described in this disclosure. The processing unit 202 may comprise a central processing unit (CPU), a microprocessor, a microcontroller, a digital signal processor, an accelerator, a graphic processing unit (GPU), a tensor processing unit (TPU), a FPGA, or an ASIC. Examples of the processing unit 202 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the processing unit 202 may execute computer-executable instructions or code stored in the memory 212 to perform various processes described below.

The at least one transceiver 204 may be configured for modulating data or other content for transmission by the at least one antenna 206 to communicate with an AP 102. The transceiver 204 is also configured for demodulating data or other content received by the at least one antenna 206. Each transceiver 204 may comprise any suitable structure for generating signals for wireless transmission and/or processing signals received wirelessly. Each antenna 206 may comprise any suitable structure for transmitting and/or receiving wireless signals. Although shown as a single functional unit, a transceiver 204 may be implemented separately as at least one transmitter and at least one receiver.

The one or more input/output components 210 is configured for interaction with a user or other devices in the communication system 100. Each input/output component 210 may comprise any suitable structure for providing information to or receiving information from a user and may be, for example, a speaker, a microphone, a keypad, a keyboard, a display, a touch screen, and/or the like.

The at least one memory 212 is configured for storing instructions executable by the processing unit 202 and data used, generated, or collected by the processing unit 202. For example, the memory 212 may store instructions of software, software systems, or software modules that are executable by the processing unit 202 for implementing some or all of the functionalities and/or embodiments of the STA 112 described herein. Each memory 212 may comprise any suitable volatile and/or non-volatile storage and retrieval components such as RAM, ROM, hard disk, optical disc, SIM card, solid-state memory modules, memory stick, SD memory card, and/or the like.

The at least one other communication component 214 is configured for communicating with other devices such as other STAs 112 via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like.

In some embodiments, a STA 112 may comprise a plurality of transceivers 204 and a plurality of antennas 206 for communication with an AP 102.

In the communication between the AP 102 and the STA 112, a transmission from the STA 112 to the AP 102 is usually denoted an uplink (UL) and the wireless channel used therefor is denoted an uplink channel. A transmission from the AP 102 to the STA 112 is usually denoted a downlink (DL) and the wireless channel used therefor is denoted a downlink channel.

In physical layer (PHY), the frequency-time resource of the channel 114 is partitioned into physical layer protocol data units (PPDUs; also called “packets”), and the AP 102 or STA 112 transmits data as PPDUs or packets. Suitable modulation technologies may be used for communication between the AP 102 and the STA 112. For example, in some embodiments, orthogonal frequency-division multiplexing (OFDM) may be used wherein the channel 114 is composed of a plurality orthogonal subcarriers for communication between the AP 102 and the STA 112. Moreover, as there are usually a plurality of STAs 112 in communication with a same AP 102, suitable multiple-access technologies may be used. For example, in some embodiments, orthogonal frequency-division multiple access (OFDMA) may be used for communication between the AP 102 and STAs 112.

It has been envisioned that 4 times repetition of 52-tone resource unit (RU) and 2 times repetition of 106-tone RU with modulation coding scheme 15 (MCS15) (i.e. 64 quadrature amplitude modulation (QAM) 5/6 modulation with two spatial streams), are considered to achieve a desired data rate as well as desired link budget gain for enhanced long range (ELR) transmission, namely a minimum data rate of 1.5 Mbps and an improvement of the uplink link budget by 6 dB.

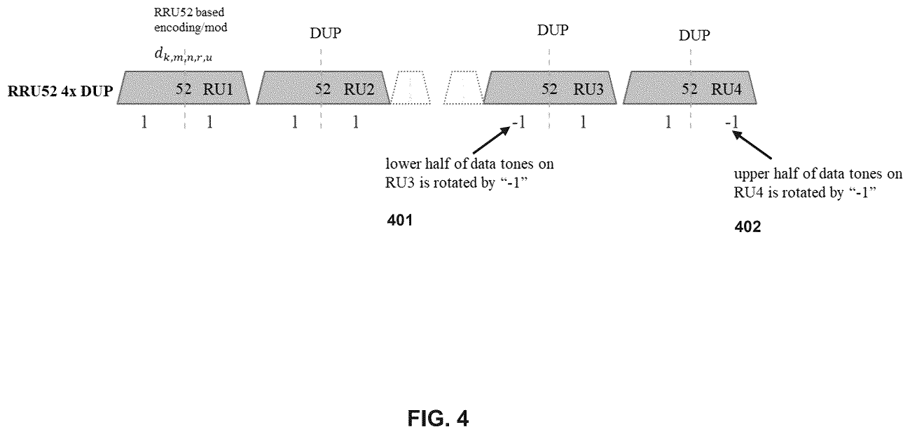

In has also been envisioned that 4 times duplication (DUP) with 52-tone regular resource unit (RRU) and a peak-to-average power ratio (PAPR) reduction mask can be used for enhanced long range (ELR) data transmission in order to preserve simplicity in signaling and implementation. FIG. 4 is a schematic diagram showing 4 times duplication with 52-tone regular resource unit (RRU) and peak-to-average power ratio (PAPR) reduction in enhanced long range (ELR) transmission. As illustrated in FIG. 4, in the second duplication (RU3) the lower half of the data tones 401 on RU3 is rotated by “−1”. In the third duplication (RU4) the upper half of the data tones 402 on RU4 are rotated by “−1”.

However, it has been realized that in the two transmission methods defined above, substantially all of the resources in the time domain and the frequency domain are used for ELR physical layer (PHY) protocol data unit (PPDU) transmission. This use of substantially all of the resources in the time domain and the frequency domain for ELR transmission can reduce the efficiency of the system. Therefore, there is a need for a new tone selection mode for ELR transmission in the UHR.

According to embodiments, there are provided new methods for ELR packet transmission by which a benefit can be derived from time-domain and frequency-domain duplication or by which benefit can be derived for a reduction of the overhead associated with data transmission.

It has been observed that there is a repetition pattern in the time domain samples of a data symbol after applying an inverse discrete Fourier transform (IDFT) when only even-indexed tones are used for transmission. As such, the use of an even-indexed tone selection method and 2×DUP of 106-tone RUs for ELR transmission in the UHR has been developed. Using this approach, there is a perceived benefit from time-domain and frequency-domain duplication without an increase in system overhead. In addition, a reduction in the overhead can be provided by truncating half of a symbol and transmitting a repetition of this truncated symbol in the time domain. Further, the transmit power can be boosted due to the sparsity of tones, wherein interpolation is not required in the instance where 2 times long training field (2×-LTF) is used.

According to embodiments, the apparatus, system and methods of the instant application are directed towards an ELR PPDU transmission in UHR. In addition, products that may be suitable for association with embodiments of the instant application can include products directed towards Wi-Fi 8 AP or one or more future communication protocols, future products or future devices.

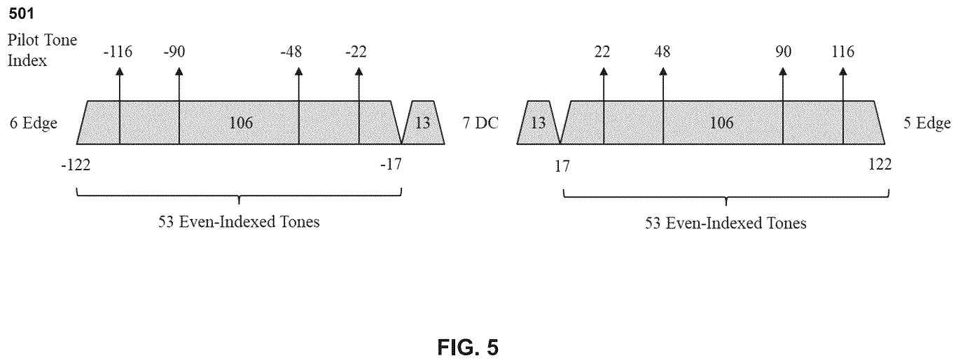

According to embodiments of the instant application, a method for communication involves the use of even-indexed tone selection in resource units (RUs) for ELR transmission. For example, for even-indexed tone selection in 106-tone RUs for ELR transmission on 20 MHz bandwidth (BW), 106-tone RRUs in 20 MHz BW have 53 even-indexed tones. FIG. 5 illustrates the data tones and pilot tones for 106-tone RRUs in 20 MHz BW. The pilot tones 501 have an index of −116, −90, −48 and −22 in the first RU and 22, 48, 90 and 116 in the second RU, wherein all of the pilot tones are even-indexed.

According to embodiments, the distributed resource unit (DRU) can also be considered in the approach defined above. For example, 106-tone DRUs for 20 MHz BW have 53 even-indexed tones and can be used for the ELR transmission according to embodiments of the instant application. In order to be aligned with current 52-tone transmission, 52 tones can be selected from the 53 even-indexed tones in each 106-tone RU for payload transmission. The unselected one even-indexed tone can be set to zero or used as an extra pilot tone if desired. In this case, a regular interleaver for 52-tone RUs can be used.

In some embodiments, the one unselected tone as defined above, can be used for data transmission in order to increase the goodput, namely to increase correct decoding of data bits on the receiver side. However, in this instance, a new design for an interleaver is needed, namely an interleaver that can be used for 106-tone RUs.

In general, it can be observed that there may be no gain by using an interleaver for the above defined transmission approach. In some embodiments, the interleaver can be disabled in order to reduce the complexity. In this instance an indication regarding an interleaver being used or an interleaver not being used, can be defined within the signal (SIG) field/trigger frame for ELR transport block (TB) PPDU.

According to embodiments, when the 48 data tones among the even indexed tones of 106-tone RU are being allocated, it can be suitable to use the 52-tone RU interleaver parameters for the interleaver as defined in IEEE 802.11ax/be. However, in instances where the 49 data tones among the even indexed tones of 106-tone RU are to be allocated, a new interleaver is to be design for association with the 49 data tones. It is to be understood that the interleaver gains can be limited for the small size RU such as 26 or 52 tone RU. So, in some embodiments, it is desired to have an option of no interleaver on the transmitter (Tx) side, and thus there would be no required de-interleaver on the receiver (RX) side for the ELR PPDU.

According to embodiments, there is provided a one bit indication regarding “No Interleaver/Interleaver” wherein this indicator bit can be assigned in the physical (PHY) header of the ELR PPDU. This indicator bit can be present in the ELR-SIG field that is located between the enhanced long range-long training field (ELR-LTF) and the ELR data portion.

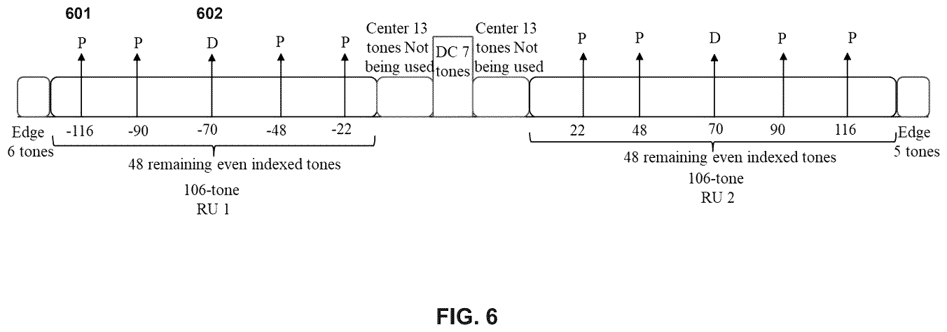

According to embodiments, an example detail tone allocation for the LTF and data symbols with the 2×-symbol transmission in ELR PPDU is illustrated in FIG. 6. It is to be understood that this tone allocation illustrated in FIG. 6 is to be considered an example and not to be considered as limiting other potentially suitable tone allocations, that would be readily understood by a person skilled in the art.

With further reference to FIG. 6, “P” 601 corresponds to the pilot tone and “D” 602 corresponds to a dummy tone allocated with a non-zero dummy value. As such, in this illustrated example there are 48 even indexed tones in each 106-tone RU excluding pilot tones and dummy tones.

According to embodiments, a method is provided wherein transmission of ELR PPDU includes 2 times duplication of even-indexed 106-tone RUs in the frequency domain (i.e. 2×ERU106). It has been realized that for transmission using this method, given that the data is positioned on even tones, the IDFT operation of the data portion creates repeated samples in the time domain.

For example, let the frequency-domain sequence be X [k] where k=0, 1, . . . , N−1. In this example, the IDFT of X [k] is given by:

$$x [ n ] = \frac{1}{N} {\sum }_{k = 0}^{N - 1} X [ k ] {e}^{j \frac{2 π kn}{N}}$$

Further, assuming that M non-zero elements are positioned on even indices, i.e., 2m, where m=0, 1 . . . , M−1. Then, the IDFT can be rewritten as below:

$$x [ n ] = \frac{1}{N} {\sum }_{m = 0}^{M - 1} X [ 2 m ] {e}^{j \frac{2 π n \times 2 m}{N}} = x [ n ] = \frac{1}{N} {\sum }_{m = 0}^{M - 1} X [ 2 m ] {( {e}^{j \frac{2 π nm}{N}} )}^{2}$$

It is understood that in order for x [n] to have repetition, x [n+N/2] is to be equal to x [n].

The value of x [n+N/2] is given by the following:

$$\begin{matrix}x [ n + N / 2 ] = \frac{1}{N} {\sum }_{m = 0}^{M - 1} X [ 2 m ] {( {e}^{j \frac{2 π ( n + N / 2 ) m}{N}} )}^{2} \\ = \frac{1}{N} {\sum }_{m = 0}^{M - 1} X [ 2 m ] {( {e}^{j \frac{2 π nm}{N}} )}^{2} {e}^{j 2 π m} \\ = x [ n ]\end{matrix}$$

As can be seen from the above evaluation, the even-indexed tone selection method according to embodiments, results in repetition of the signal in the time-domain. Moreover, due to sparsity of the tones, the transmit power can be boosted by 3 dB. Accordingly, 2×-LTF is applicable and no interpolation is required at the receiver side since no odd tone is occupied for data transmission.

According to embodiments, a method is provided wherein transmission of ELR PPDU can use two times duplication of 52-tone distributed resource units (DRUs) in a tone plan wherein these DRUs are occupying even-indexed tones only.

In some embodiments, instead of using this duplication with respect to one user, each of the even-indexed 106-tone RUs in the frequency domain can be used for two different users.

In some embodiments, the even-indexed 52-tone RUs (i.e. namely the 26 even tones thereof) can be considered for 4 times duplication in the frequency domain. Alternately the even-indexed 52-tone RUs (i.e. namely the 26 even tones thereof) for transmission of data to multiple different users, e.g. up to 4 different users.

According to embodiments, in light of the identified two times duplication of even-indexed 106-tone RUs in the frequency domain, after taking IDFT, there are three approaches that can be considered for payload transmission in time domain.

As a first approach, the whole symbol can be transmitted together with a guard interval (GI). As a second approach, the transmitter (Tx) can truncate half of the symbol, add a GI and transmit the resulting signal (i.e. half of the symbol and the GI) twice, thereby benefitting from the time-domain duplication. As a third approach, the transmitter (Tx) can truncate half of the symbol, add a GI and transmit the resulting signal (i.e. half of the symbol and the GI) once, thereby reducing overhead, namely reducing system resources used for transmission.

With the above embodiments, on the receiver (Rx) side, the Rx removes the GI, appends each repeated portion in the time-domain to itself and then applies a discrete Fourier transform (DFT) thereby obtaining the complete symbol.

By using either the first approach or the second approach, there is provided two times duplication of frequency domain sequences which is two times duplication of the data. As such, it is possible to achieve 4× duplication when accounting for both the frequency domain and the time domain.

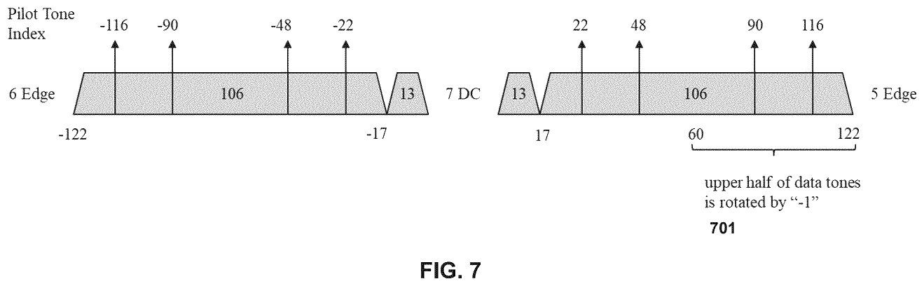

It is understood that generally, the power-to-average power ratio (PAPR) for ELR transmission with duplication is high. According to embodiments, in order to reduce the PAPR for ELR transmission with duplication, a PAPR reduction mask can be used. For example, phase rotations of −1 can be applied on the data subcarriers of the upper half of ERU106_2. Using this form of PAPR reduction mask, the PAPR can be reduced significantly. FIG. 7 is a schematic diagram showing a PAPR reduction mask according to embodiments of the present disclosure, wherein the upper half of the data tones 701 are rotated by −1.

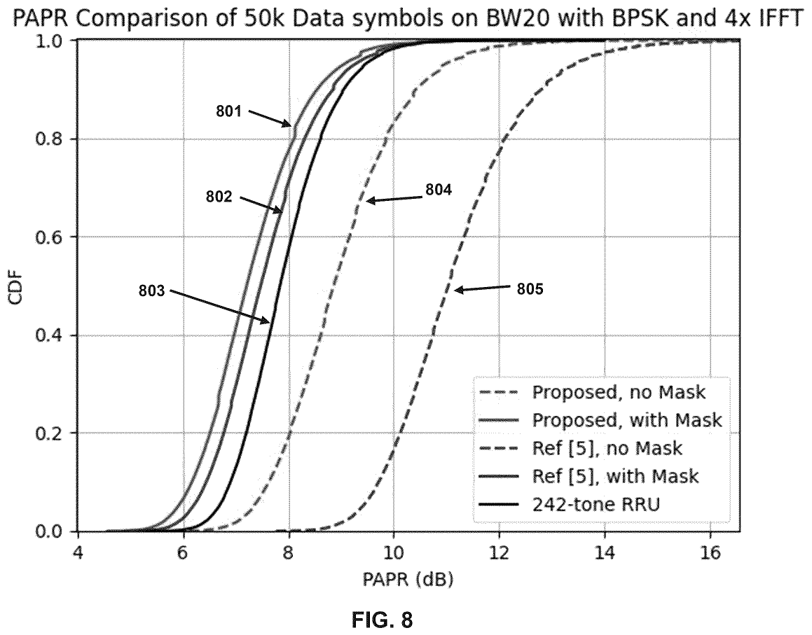

FIG. 8 is a graph showing PAPR comparison of 50 k Data Symbols on BW 20 MHz with binary phase shift keying (BPSK) and 4× inverse fast Fourier transform (IFFT), according to embodiments of the present disclosure. In particular, FIG. 8 illustrates the cumulative distribution function (CDF) vs PAPR (dB) for multiple methods of ELR transmission, including methods according to embodiments of the instant application without a mask 804 or with a mask 801; BPSK with a mask 802 or without a mask 805; and 242-tone RRU 803. It can be seen that the methods according to the instant application for ELR transmission outperform those proposed with BPSK.

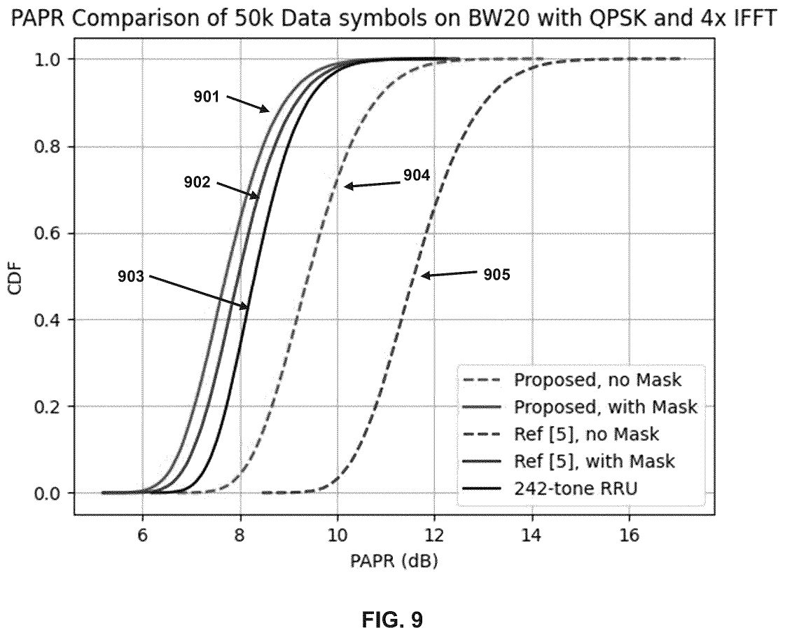

FIG. 9 is a graph showing PAPR comparison of 50 k Data Symbols on BW 20 MHz with quadrature phase shift keying (QPSK) and 4×IFFT, according to embodiments of the present disclosure. In particular, FIG. 9 illustrates the CDF vs PAPR (dB) for multiple methods of ELR transmission, including methods according to embodiments of the instant application without a mask 904 or with a mask 901; QPSK with a mask 902 or without a mask 905; and 242-tone RRU 903. It can be seen that the methods according to the instant application for ELR transmission outperform those proposed with QPSK.

It has been suggested that two different data rates (i.e. 3 Mbps and 1 Mbps) be used for the ELR PPDU with the corresponding 5 dB and 8 dB range extension over the 802.11g MCSO transmission. However, it would be know that when the ELR devices are located in the 0 dB to 5 dB extended range, it is considered a mid-range extension, and as such devices typically use (or are obliged to use) the scheme of 3 Mbps with the 5 dB extended range.

It is desired to include an optional scheme which defines the 2×-symbol length using the repetition property in the time domain as defined elsewhere herein, which can achieve about a 3 dB range extension with the 6 Mbps data rate being maintained.

The inclusion of this new data rate of 6 Mbps with a 3 dB range extension as an additional option for use as the data rate for the ELR PPDU is desired. However as is known, only one bit has been assigned for the ELR-MCS in the ELR-SIG field of the ELR PPDU.

In order to overcome this issue, it is desired to increase the number of bits associated with the ELR-MCS in the ELR-SIG field of ELR PPDU to a total of two bits in order to accommodate the identification, or selection, of the new data rate of 6 Mbps with a 3 dB range to support this mid-range extension with the data rate still provided at 6 Mbps.

According to embodiments, there is provided a method for using even-indexed tone selection for transmission in the ultra high reliability (UHR).

According to embodiments, there is provided a method for 2 times duplication of even-indexed 106-tone resource units (RUs) in frequency domain for enhanced long range (ELR) data transmission.

According to embodiments, since the data is positioned on even tones, the inverse discrete Fourier transform (IDFT) operation of the data portion creates repeated samples in the time domain.

According to embodiments, it is considered suitable to boost the transmit power by 3 dB due to the sparsity of the tones associated with only using even-indexed tone selection.

According to embodiments, by using an even-indexed tone selection for transmission in the UHR and 2 times duplication of even-indexed 106-tone RUs in frequency domain for ELR data transmission, there is a perceived benefit from time-domain and frequency-domain duplication with no increased overhead.

According to embodiments, it is considered suitable to truncate half of the symbol, add a guard interval (GI) and transmit the resulting signal twice to benefit from time-domain duplication as well as frequency-domain duplication.

According to embodiments, it is considered suitable to truncate half of the symbol, add a GI and transmit the resulting signal once in order to reduce overhead associated with the transmission resources being used.

According to embodiments, a method wherein 2×-symbol length using the repetition property in the time domain which achieves about 3 dB range extension with the 6 Mbps data rate is provided. The identification, or selection, of the method of transmission associated with the new data rate of 6 Mbps with a 3 dB range can be provided by increasing the ELR-MCS in the ELR-SIG field of an ELR PPDU to a total of two bits.

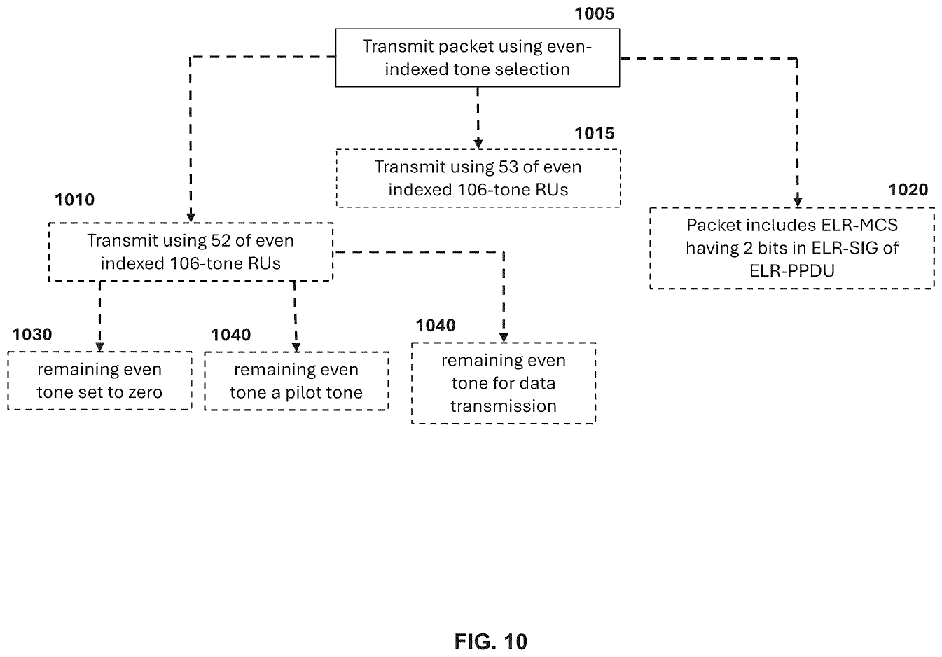

FIG. 10 illustrates an enhanced long range communication method according to embodiments of the present disclosure. The ELR communication method includes transmitting 1005 a packet using even-indexed tone selection for ELR transmission.

In some embodiments, 53 of the even indexed 106-tone RUs are used for transmission 1015. In some embodiments, 52 of the even indexed 106-tone RUs are used for data transmission 1010. In some embodiments, the remaining even indexed 106-tone RU 1030 is set to zero. In some embodiments the remaining even indexed 106-tone RU 1040 is configured as an extra pilot tone. In some embodiments, the remaining even indexed 106-tone RU 1040 is also used for data transmission.

In some embodiments, the packet further includes 1020 an enhanced long range modulation coding scheme (ELR-MCS) having two bits in an enhanced long range signal (ELR-SIG) field of an enhanced long range physical layer protocol data unit (ELR-PPDU).

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form. Depending on the functionalities of various features of the methods disclosed herein, some features may be implemented on the network side (such as in one or more APs), some other features may be implemented on the STA side, and/or yet some other features may be implemented on both the AP and the STA sides. Depending on the functionalities of various features of the methods disclosed herein, some features may be implemented on the transmitting side (such as in one or more APs and/or one or more STAs for transmission), some other features may be implemented on the receiving side (such as in one or more APs and/or one or more STAs for receiving), and/or yet some other features may be implemented on both the transmitting and the receiving sides.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. An enhanced long range (ELR) communication method comprising:
transmitting a packet using even-indexed tone selection for ELR transmission.

2. The ELR communication method according to claim 1, wherein the transmitting includes the packet using two times duplication of even-indexed 106-tone resource units (RUs) in frequency domain.

3. The ELR communication method according to claim 1, wherein 52 of the even indexed 106-tone RUs are used for data transmission and a remaining even indexed 106-tone RU is set to zero or is configured as an extra pilot tone.

4. The ELR communication method according to claim 1, wherein 53 of the even indexed 106-tone RUs are used for data transmission.

5. The ELR communication method according to claim 1 wherein the packet further includes an enhanced long range modulation coding scheme (ELR-MCS) having two bits in an enhanced long range signal (ELR-SIG) field of an enhanced long range physical layer protocol data unit (ELR-PPDU).

6. The ELR communication method according to claim 1, wherein transmit power in a data portion is boosted by 3 dB.

7. One or more circuits for performing a method comprising:
transmitting a packet using even-indexed tone selection for ELR transmission.

8. The one or more circuits according to claim 7, wherein the transmitting includes the packet using two times duplication of even-indexed 106-tone resource units (RUs) in frequency domain.

9. The one or more circuits according to claim 7, wherein 52 of the even indexed 106-tone RUs are used for data transmission and a remaining even indexed 106-tone RU is set to zero or is configured as an extra pilot tone.

10. The one or more circuits according to claim 7, wherein 53 of the even indexed 106-tone RUs are used for data transmission.

11. The one or more circuits according to claim 7 wherein the packet further includes an enhanced long range modulation coding scheme (ELR-MCS) having two bits in an enhanced long range signal (ELR-SIG) field of an enhanced long range physical layer protocol data unit (ELR-PPDU).

12. The one or more circuits according to claim 7, wherein transmit power in a data portion is boosted by 3 dB.

13. One or more non-transitory computer-readable storage devices comprising computer-executable instructions, wherein the instructions, when executed, cause one or more circuits to perform a method comprising:
transmitting a packet using even-indexed tone selection for ELR transmission.

14. The one or more non-transitory computer-readable storage device according to claim 13, wherein the transmitting includes the packet using two times duplication of even-indexed 106-tone resource units (RUs) in frequency domain.

15. The one or more non-transitory computer-readable storage device according to claim 13, wherein 52 of the even indexed 106-tone RUs are used for data transmission and a remaining even indexed 106-tone RU is set to zero or is configured as an extra pilot tone.

16. The one or more non-transitory computer-readable storage device according to claim 13, wherein 53 of the even indexed 106-tone RUs are used for data transmission.

17. The one or more non-transitory computer-readable storage device according to claim 13, wherein the packet further includes an enhanced long range modulation coding scheme (ELR-MCS) having two bits in an enhanced long range signal (ELR-SIG) field of an enhanced long range physical layer protocol data unit (ELR-PPDU).

18. The one or more non-transitory computer-readable storage device according to claim 13, wherein transmit power in a data portion is boosted by 3 dB.
